(19) United States
(12) Patent Application Publication
(10) Pub. No.: US 2007/0137348 A1
(43) Pub. Date: Jun. 21, 2007

(54) Roller screw drive

(76) Inventor: Jurgen Oetjen, Herzogenaurach (DE)

Correspondence Address: HEDMAN & COSTIGAN P.C., 1185 AVENUE OF THE AMERICAS, NEW YORK, NY, 10036, US

(21) Appl. No.: 10/580,091

(22) PCT Filed: Nov. 9, 2004
(86) PCT No.: PCT/EP04/12639

§ 371 Date: May 18, 2006

(30) Foreign Application Priority Data
Nov. 19, 2003 (DE) 10354064.4

(51) Int. Cl. F16H 1/24

(52) U.S. Cl. 74/424.86

(57) ABSTRACT

A roller screw drive having a spindle nut (2) arranged on a threaded spindle (1), and having rollers (3) which are arranged such that they can roll in a thread path (4), the thread path (4) being delimited by thread grooves (8a, 11, 20) provided on the threaded spindle (1) and on the spindle nut (2), the two equal pitches (p) of the thread grooves (8a, 11, 20) being arranged so as to be axially offset with respect to one another by a partial amount (a) of the pitch (p).

The present invention relates to a roller screw drive in which a spindle nut is rotatably arranged on a threaded spindle. Roller screw drives of this type convert a relative rotational movement between the threaded spindle and the spindle nut into a translatory movement between the threaded spindle and the spindle nut.

A roller screw drive has become known, for example, from JP 07-077261 A, in which the rollers are arranged such that they can roll in a thread path, the thread path being delimited by thread grooves provided on the threaded spindle and on the spindle nut. The spindle nut is formed in two parts, a separation plane being arranged transversely with respect to the rotational axis of the threaded spindle. A first roller set is arranged between the first nut part and the threaded spindle, and a second roller set is arranged between the second nut part and the threaded spindle. The rollers of the first roller set roll in a first thread path formed by thread grooves provided on the threaded spindle and on the first nut part. The rollers of the second roller set roll on a second thread path which is formed by thread grooves formed on the threaded spindle and on the second nut part. Each thread groove is delimited by two thread flanks. The rollers roll on thread flanks, which face one another, of the thread groove of the threaded spindle and the thread groove of the respective nut part. The rotational axes of the rollers of the first roller set and the rotational axes of the rollers of the second roller set are approximately perpendicular to one another. A spacer which keeps the two nut parts at an axial distance from one another is provided between the two nut parts.

An annular gap, through which the two roller body sets pass, is formed between the inner circumference of the spindle nut and the outer circumference of the threaded spindle. For satisfactory lubrication of the roller screw drive, it is appropriate to introduce lubricating means into said annular gap. Since said annular gap is however too small, only a small amount of lubricant can be introduced. On account of the lack of space, it is also not possible to introduce lubricant into the region of the thread path. A short lubrication interval may be necessary for this reason.

It is an object of the present invention to specify a roller screw drive according to the features of the preamble of claim 1, in which said disadvantage is eliminated.

According to the invention, this object is achieved in that the two equal pitches of the thread grooves are arranged so as to be axially offset with respect to one another by a partial amount of the pitch. The pitch is measured by traveling exactly 360° along a thread flank from a starting point on said thread flanks to an end point, the axial distance between the starting point and the end point indicating the pitch. In other words, the invention is comprised in that the thread flanks of the thread groove are longer than the rollers, a free space being formed between end sides of the rollers and thread flanks situated opposite said end sides. This free space which is formed in this way is available as an additional lubricant reservoir.

In the roller screw drive known from the abovementioned document, the rolling faces of rollers which are arranged adjacent to one another are in rolling contact. This means increased friction. In the roller screw drive according to the invention, it is possible to provide a cage for guiding the rollers, the rollers being held in the pockets of said cage and the cage having belts and said belts having webs connecting them to one another. The advantage is that the belts of the cage can be arranged in the free space according to the invention. The webs and the free space loop around the rotational axis of the roller screw drive in the manner of a screw. The belts of the cage, which are arranged at a distance from one another, span one plane, the rotational axes of the rollers being arranged parallel to said plane and transversely with respect to belts.

The roller screw drive according to the invention can, like the known roller screw drive, have a spindle nut which is formed in two parts, a first roller set formed from rollers being arranged such that it can roll in a first thread path, and a second roller set being arranged such that it can roll in a second thread path. The first roller set is arranged in the first nut part and the second roller set is arranged in the second roller part. The rollers of the first roller set can roll on one thread flank of the thread groove of the threaded spindle, and the rollers of the second roller set can roll on the other thread flank of the thread groove of the threaded spindle. A spacer can be provided which keeps the two nut parts at an axial distance from one another and defines an axial distance dimension which is such that the nut parts of the spindle nut are kept in a prestressed state with the threaded spindle.

In this way, the roller screw drive is embodied without play.

In a particularly preferred roller screw drive, the two thread flanks of the thread grooves are perpendicular to one another, the partial amount of the pitch by which the two thread grooves of the spindle nut and of the threaded spindle are offset with respect to one another corresponding to approximately 30%, preferably 28%, of the absolute value of the pitch.

The invention is described in more detail in the following on the basis of an exemplary embodiment which is depicted in two figures, in which:

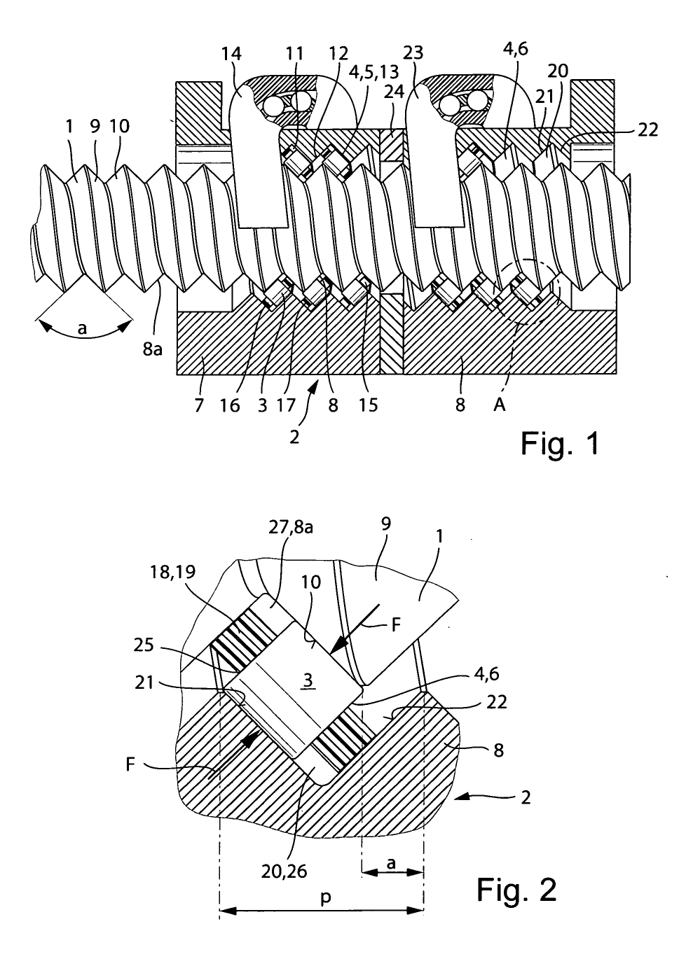

FIG. 1 shows a longitudinal section through a roller screw drive according to the invention and

FIG. 2 shows a detail of the roller screw drive in FIG. 1 in an enlarged illustration.

FIG. 1 shows a longitudinal cross section through a roller screw drive according to the invention, having a spindle nut 2 which is rotatably arranged on a threaded spindle 1. Rollers 3 are arranged such that they can roll in a thread path 4. Here, the thread path 4 is divided into a first thread path 5 and a second thread path 6.

The spindle nut 2 is formed here in two parts and comprises a first nut part 7 and a second nut part 8. The two nut parts 7, 8 are arranged one behind the other axially, a separation plane being arranged transversely with respect to the rotational axis of the roller screw drive.

The first thread path 5 is formed by a thread groove 8a which is formed on the threaded spindle 1 and is delimited by two thread flanks 9, 10. The thread flanks 9 and 10 are perpendicular to one another. In addition, the first thread path 5 has a thread groove 11 provided on the first nut part 7. The thread groove 11 is delimited by thread flanks 12, 13.

The rollers 3 arranged between the first nut part 7 and the threaded spindle 1 form a first roller set which is continuously encircling. For this purpose, a deflecting channel 14 which is known per se is provided, being the first roller set is deflected from an end of the first thread path 5 to a start of the first thread path 5 in said channel 14. In the present case, the deflecting channel 14 is arranged outside the first nut part 7.

The first roller set comprises a cage 15 for guiding the rollers 3. The cage 15 has pockets 16 in which the rollers 3 are arranged. The cage 15 has belts 17, and said belts 17 have webs, which are not depicted in more detail here, connecting them to one another. The belts 17 are arranged at a distance from one another and span one plane, the rotational axes of the rollers 3 being arranged parallel to said plane and transversely with respect to the belts 17.

A second roller set is arranged between the second nut part 8 and the threaded spindle 1. Said second roller set likewise has a cage 18, having belts 19 and webs. The second nut part 8 has a thread groove 20 which is delimited by thread flanks 21, 22 which are perpendicular to one another. As is the case for the first nut part 7, a deflecting channel 23 is also provided for the second nut part 8.

A spacer 24, which keeps the two nut parts 7, 8 at an axial distance from one another, is arranged between the two nut parts 7, 8.

FIG. 2 shows an enlarged illustration of a detail A indicated by a circle in FIG. 1, the threaded spindle 1, the second nut part 8 and the second roller set, which is arranged between the threaded spindle 1 and the second nut part 8, being illustrated here.

The thread groove 20 of the second nut part 8 can be clearly seen in the enlarged diagram of FIG. 2, the thread groove 20 being delimited by the thread flanks 21, 22. The rollers 3 roll, at their circumference, on the thread flank 21 of the second nut part 8 and on the thread flank 10 of the threaded spindle 1.

As is the case for the first roller set, the cage 18 of the second roller set has pockets 25 for the rollers. The cage 18 has two belts 19 which are arranged at a distance from one another and span one plane, in parallel with which the rotational axis of the rollers 3 is arranged. The rotational axes of the rollers 3 are arranged transversely with respect to said belts 19.

It can be seen from FIG. 2 that the rollers 3 roll, at their lateral surface, on the thread flanks 10 of the threaded spindle 1 and on the opposing thread flanks 21 of the second nut part 8.

It can be clearly seen from FIG. 2 that the thread flanks 10, 21 are longer than the rollers 3 when seen in longitudinal cross section. In this way, a free space 26 is formed in the thread groove 20, and a free space 27 is formed in the thread groove 8a. Said free space 26, 27 which is formed in this way serves both to hold and guide the belts 19 of the cage 18 and also as a lubricant reservoir. In contrast to the known roller screw drive, considerably more lubricant can be accommodated in the roller screw drive according to the invention, so that the lubricating intervals are lengthened considerably.

It can also be seen from FIG. 2 that the thread groove 8a of the second nut part 8 has a pitch p. The threaded spindle 1 has the same pitch p. FIG. 2 also shows that the thread groove 8a of the threaded spindle 1 and the thread groove 20 of the second nut part 2 are arranged such that they are offset with respect to one another by the amount a. Said amount a is a partial amount of the pitch p. If, as is the case here, the thread flanks 21, 22 of the thread groove 20 and the thread flanks 9, 10 of the threaded spindle 1 are arranged perpendicular to one another, it is particularly advantageous if the partial amount a corresponds to approximately 30%, preferably 28%, of the pitch p. This dimensioning results in particularly favorable conditions for forming the free space according to the invention, said free space serving both as a lubricant reservoir and as a cage holder.

Here, the pitch p is 10 mm, the roller diameter is 5 mm and the nominal diameter of the threaded spindle 1 is 32 mm. In this arrangement, it is ideal if the partial amount a is 2.8 mm.

Corresponding ratios are implemented in the first nut part 7.

### List of Reference Designations

1 Threaded spindle
2 Spindle nut
3 Roller
4 Thread path
5 First thread path
6 Second thread path
7 First nut part
8 Second nut part
8a Thread groove
9 Thread flank
10 Thread flank
11 Thread groove
12 Thread flank
13 Thread flank
14 Deflecting channel
15 Cage
16 Pocket
17 Belt
18 Cage
19 Belt
20 Thread groove
21 Thread flank
22 Thread flank
23 Deflecting channel
24 Spacer
25 Pocket
26 Free space
27 Free space

1. A roller screw drive having a spindle nut (2) arranged on a threaded spindle (1), and having rollers (3) which are arranged such that they can roll in a thread path (4), the thread path (4) being delimited by thread grooves (8a, 11, 20) provided on the threaded spindle (1) and on the spindle nut (2), wherein the two equal pitches (p) of the thread grooves (8a, 11, 20) are arranged so as to be axially offset with respect to one another by a partial amount (a) of the pitch (p).

2. A roller screw drive having a spindle nut (2) arranged on a threaded spindle (1), and having rollers (3) which are arranged such that they can roll in a thread path (4), the thread path (4) being formed by thread grooves (8a, 11, 20) provided on the threaded spindle (1) and on the spindle nut (2), which thread grooves (8a, 11, 20) are each delimited by two thread flanks (9, 10, 12, 13, 21, 22), the rollers (3) rolling on thread flanks (9, 10, 12, 13, 21, 22), which face one another, of the two thread grooves (8a, 11, 20), wherein the thread flanks (9, 10, 12, 13, 21, 22) are longer than the rollers (3), a free space (26, 27) being formed between end sides of the rollers and thread flanks (9, 10, 12, 13, 21, 22) situated opposite said end sides.

3. The roller screw drive of claim 2, in which the free space (26, 27) is formed as a lubricant reservoir.

4. The roller screw drive of claim 1, in which a cage (15, 18) is provided for guiding the rollers, rollers (3) being held in the pockets (16, 25) of said cage (15, 18), the cage (15, 18) having belts (17, 19) having webs connecting them to one another, the belts (17, 19) being arranged in the free space (26, 27).

5. The roller screw drive of claim 4, in which the belts (17, 19), which are arranged at a distance from one another, span one plane, the rotational axes of the rollers (3) being arranged parallel to the plane and transversely with respect to belts (17, 19).

6. The roller screw drive of claim 4, in which the webs and the free space (26, 27) loop around the rotational axis of the roller screw drive in the manner of a screw.

7. The roller screw drive of claim 1, in which a first roller set formed from rollers (3) is arranged such that it can roll in a first thread path (5), and a second roller set is arranged such that it can roll in a second thread path (6).

8. The roller screw drive of claim 7, in which the rotational axes of the rollers (3) of the first roller set are arranged at an angle to the rotational axes of the rollers (3) of the second roller set.

9. The roller screw drive of claim 8, in which rollers (3) of the first roller set are arranged such that they can roll on one thread flank (9) of the thread groove (8a) of the threaded spindle (1), and the rollers (3) of the second roller set are arranged such that they can roll on the other thread flank (10) of the thread groove (8a) of the threaded spindle (1).

10. The roller screw drive of claim 9, in which the spindle nut (2) has two first and second nut parts (7, 8) arranged one behind the other axially, the first roller set being arranged in the first nut part (7) and the second roller set being arranged in the second nut part (8).

11. The roller screw drive of claim 10, in which a spacer (24) is provided which keeps the two nut parts (7, 8) at an axial distance from one another and defines an axial distance dimension which is such that the nut parts (&, 8) are kept in a prestressed state with the threaded spindle (1).

12. The roller screw drive of claim 1, in which the two thread flanks (9, 10, 12, 13, 21, 22) of the thread groove (8a, 11, 20) are perpendicular to one another, the partial amount (a) corresponding to approximately 30%, preferably 28%, of the absolute value of the pitch (p).
